(19) United States
(12) Patent Application Publication
(10) Pub. No.: US 2011/0044246 A1
(43) Pub. Date: Feb. 24, 2011

(54) SYSTEM AND METHOD FOR PROVIDING TWO-WAY COMMUNICATIONS NETWORK TRANSMISSIONS OVER INTERNET PROTOCOL

(75) Inventor: Eyal FISHLER, Tel Aviv (IL)

Correspondence Address: HOGAN LOVELLS US LLP;IP GROUP, COLUMBIA SQUARE, 555 THIRTEENTH STREET, N.W., WASHINGTON, DC, 20004, US

(73) Assignee: MOBILE TORNADO INTERNATIONAL LTD., Dublin (IE)

(21) Appl. No.: 12/853,145

(22) Filed: Aug. 9, 2010

Related U.S. Application Data
(63) Continuation of application No. 10/488,685, filed on Dec. 9, 2004, now abandoned.

(30) Foreign Application Priority Data
Sep. 6, 2001 (IL) PCT/IL01/00846
Aug. 22, 2002 (IL) PCT/IL02/00700

(51) Int. Cl. H04W 40/00

(52) U.S. Cl. 370/328

(57) ABSTRACT

A system and method for an improved two-way packet-centric like radio communication network that transmits signals and data over Internet Protocol. The improved like radio communications network provides advanced features and enhanced services to its users, such as the capability of roaming across a plurality of similar like radio communications networks. A plurality of client devices including an enhanced client application for the operation of two-way like radio networks that accesses, contacts, and communicates with one or more client devices of the same network or one or more client devices of different like radio networks. The radio network includes an optional server application to establish packet-based radio communications between at least two client devices within a single radio network or across a plurality of radio networks.

### RELATED APPLICATIONS

This application claims priority from PCT application number PCT/IL01/00846, filed 6 Sep. 2001, and titled “METHOD AND SYSTEM FOR PROVIDING TWO-WAY RADIO COMMUNICATIONS NETWORK TRANSMISSIONS OVER INTERNET PROTOCOL”

### BACKGROUND OF THE INVENTION

1. Field of the Invention

The present invention relates in general to communications systems, and more particularly, to a system and method for packet-centric transmission of messages within and between two-way like radio communications systems implemented across wireless telephone networks using Internet Protocol.

2. Discussion of the Related Art

A two-way radio communications network is a flexible, versatile and inexpensive tool for keeping in touch within an organization. A radio network is typically operative in connecting individuals spread out over a limited area, such as in construction work, in security coverage of public events, in television or movie productions, and the like. Two-way radio equipment can be established at a stationary location such as a central office, mounted in moving vehicles or built into battery-powered hand-portable units. In a two-frequency system, transmitters operate on one frequency, receivers on another. Accordingly, although mobile and portable units cannot talk to each other, the central operator monitors the users of the system. When the operator desires to call one or more field units the message reaches every radio unit that is switched on. Although typically the range of a two-way radio network is limited to a few miles, repeater systems can be utilized to receive signals from mobile and portable units and re-transmit them. As a result wider area coverage can be achieved. Wide area radio networks are often used by agencies, such as the military, the police, fire services and other emergency services, which can operate as separate users but also need the ability to use the same infrastructure. Various applications, such as local government, cargo fleets, and organization of large public events, can be assigned user groups within a radio system and be charged according to use. Radio networks are typically used by taxi companies, paramedic squads, police departments, and amateur radio operators. Campus environments such as manufacturing plants, transportation centers, universities and hospitals can also take advantage of on-site two-way radio by coordinating the activities of large groups of people within a limited area. Two-way radio technology provides unique benefits to the users, such as instant and direct connectivity via wireless voice communication, group calls and private calls without the necessity of setting up conference calls, and unit-to-unit communications.

Alongside the advantages the current two-way radio networks have a number of significant drawbacks. The establishment of a network has to be authorized by a third party. Thus, to set up an operational network an organization has to apply via the regulating bodies for registration, authorization, frequency allocation, and operating license.

Another disadvantage concerns the transmission range of such networks. The range of a typical radio network is limited for a few miles and the extension of the operational area involves significant expenses.

Yet another disadvantage of the two-way radio networks concerns the number of available transmission channels. The number of channels is substantially limited to a range extending from 1 to 40. As the cost of the network is directly proportional to the number of utilized channels, in the majority of the radio networks the transmitting/receiving devices operate in the half-duplex mode.

Still another serious disadvantage of the typical radio networks concerns the cost thereof. The mobile/fixed transmitting/receiving devices are typically unique for the type of the network and have to be purchased at a considerable expense.

Yet another disadvantage of the two-way radio networks is that currently networks provide only narrow-band channels (typically voice-grade channels) that limit the information transmitted to voice only. Thus, no rich media, such as pictures, graphics, video, music, data, and the like can be transmitted.

A further significant drawback of a two-way radio network concerns the lack of the roaming feature. Unlike a mobile subscriber of cellular communications network whom is automatically “handed off” between regional communication centers when traveling, a user of a two-way radio is limited to use a specific network operating in a specific area. In order to connect to a different network, complex procedures has to be taken such as specific dialing through the PSTN or through cellular networks where the connection is accomplished at a price.

In would be easily understood by one with ordinary skills in the art that a need exists for an improved two-way radio network having advanced features. Specifically there is a need of an improved and advance radio network that will combine the above listed advantages of a conventional system with added and useful features, such as roaming capability, a substantially large number of communication channels, wider area coverage involving simplified operating procedures, and the transmission of information in rich media format, such as pictures, video, music, graphics, and text. Preferably the desired system should provide diverse advanced functions, such as e-mail connectivity, e-commerce applications, and other useful services provided routinely today by the sufficiently advanced communications networks.

### SUMMARY OF THE PRESENT INVENTION

One aspect of the present invention regards a computing and communications environment accommodating at least two client systems and a method of two-way packet-centric transmission of messages between the at least two client systems. The method comprises the steps of establishing the definitions of the at least one communications sub-network on at least one client system, accepting requests submitted by the at least one client system; concerning the modification of the at least one client system operating status, mediating contact between at least two client systems by transferring two-way signaling messages representing communication requests introduced by at least one first client system attempting to contact an at least one second client system and responses concerning acknowledgement of the contact submitted by the at least one second client system, substantiating at least one two-way packet-based communications channel between the at least one client system and the at least one second client system, transporting two-way packet-based messages between at least two client systems and thereby providing two-way packet-based transmission of control signals and messages between the at least two client systems.

A second aspect of the present invention regards a computing and communicating environment having a system for the two-way packet-based transmission of messages between at least two client devices. The system comprises the elements of: at least one first client device operated by a subscriber of a communications sub-network to access, to contact, and to communicate with at least one second client devices, and to store a users database constituted of suitable data structures for the definition of at least one packet-based communications sub-network with associated definitions of at least two client devices, at least one cellular communications network to be utilized as the infrastructure to the transmission of signaling messages and data transfer between at least two client devices, at least one gateway device to provide to at least one first client device in an at least one first communication network the option of accessing, contacting and communicating with the at least one second client device in at least second communications network.

A third aspect of the present invention regards a method of two-way packet-centric connection and transmission of messages between two or more client devices. The method comprises the steps of a client application located on a client device obtaining at user information from the client internal address book, the client selects at least one destination client to communicate with, the client application resolves the destination client address, the client transmits an invitation to the destination client and a direct link is established between the client and the destination client. The step of obtaining can be accomplished by the user typing the destination client identification manually. The step of resolving also comprises looking up the destination client address in the client internal address book. The step of resolving also comprises looking up the destination client address within the client's data storage area. The step of resolving also comprises accessing a third party server which is part of the cellular network and obtaining the destination client address. The step of transmitting also comprises transmitting of destination client identification, destination client IP or destination client telephone number. The step of transmitting also comprises transmitting of destination client port, coder/decoder routine, and the identification of the first client. The step of transmitting comprises the steps of sending a message to a third party server located on a cellular network, the message to include the telephone number of the destination client and the first client address and the destination client receiving the message and initiating a connection directly through the client address. The step of transmitting further comprises of sending the destination client an invitation to establish a link directly using the destination client address. The method also comprises the step of the client accepting an acknowledgement message from the destination client. The method also comprises the step of the client receiving identification information from the destination client. The address is an IP address.

A fourth aspect of the present invention regards an apparatus for establishing a two-way packet-centric connection and transmitting of messages between at least two client devices. The apparatus comprises a first client application on a first client device programmed for obtaining at least one user information from the first client internal address book, for selecting the at least one destination client to communicate with, for resolving the destination client address and for transmitting an invitation to the destination client, whereby a direct link is established between the first client and the destination client. The application enables the user to type the destination client identification manually. The application is programmed to perform resolving by looking up the destination client address in the first client internal address book. The application is programmed to perform resolving by looking up the destination client address within the first user's client data storage area. The application is programmed to perform resolving by accessing a third party server which is part of the cellular network and obtaining the destination client address. The application further transmits the destination client identification, destination client IP or destination client telephone number. The application further transmits the destination client port, coder/decoder routine, and the identification of the first client. The application is programmed to send a message to a third party server located on a cellular network, the message to include the telephone number of the destination client and the first client address and the destination client receiving the message and initiating a connection directly through the first client address. The application further transmits the destination client an invitation to establish a link directly using the destination client address. The application is programmed to accept an acknowledgement message from the destination client. The application is programmed to receive identification information from the destination client.

A fifth aspect of the present invention regards a computing and communications environment accommodating at least two client systems connectable to at least one server system, and a method of two-way packet-centric transmission of radio messages between the at least two client systems. The method comprises the steps of: establishing the definitions of the at least one radio communications sub-network on the at least one server system, accepting requests submitted by the at least one client system; concerning the modification of the at least one client system operating status, establishing a contact between at least two client systems by the transfer of two-way radio signaling messages representing communication requests introduced by at least one first client system attempting to contact an at least one second client system and responses concerning acknowledgement of the contact submitted by the at least one second client system, substantiating at least one two-way packet-based radio communications channel between the at least one client system and the at least one second client system, and transporting two-way packet-based radio messages between at least two client systems. Thereby two-way packet-based radio transmission of control signals and messages between the at least two client systems via the at least one server system is provided.

A sixth aspect of the present invention regards a computing and communicating environment having a system for the two-way packet-based transmission of radio messages between at least two client devices. The system comprises the elements of at least one first client device operated by a subscriber of a radio communications sub-network to access, to contact, and to communicate with at least one second client devices, at least one server device to mediate requested contact between the at least one first client devices and the at least one second client devices, at least one users server device to store a users database constituted of suitable data structures for the definition of at least one packet-based communications sub-network with associated definitions of at least two client devices, at least one cellular communications network to be utilized as the infrastructure to the transmission of signaling messages and data transfer between at least two client devices via the at least one server device, and at least one gateway device to provide to at least one first client device in an at least one first radio communication network the option of accessing, contacting and communicating with the at least one second client device in at least second radio communications network.

A seventh aspect of the present invention regards a computing and communications environment accommodating at least two client systems connectable to at least one server system, and a method of two-way packet-centric transmission of radio messages between the at least two client systems. The method comprises the steps of: establishing the definitions of the at least two radio communications sub-network on the at least one server system, accepting requests submitted by the at least one client system associated with at least one radio communication sub-network concerning the modification of the at least one client system operating status, mediating contact between at least two client systems by transferring two-way packet-based radio signaling messages representing communication requests introduced by at least one first client system associated with a first communications sub-network attempting to contact an at least one second client system associated with at least one second communications sub-network and responses concerning acknowledgement of the contact submitted by the at least one second client system associated with at least one second communications sub-network, substantiating at least one two-way packet-based radio communications channel between the at least one client system associated with at least one first radio communications sub-network and the at least one second client system associated with at least one second radio communications sub-network, and transporting two-way packet-based radio messages between the at least first client system associated with the at least first radio communications sub-network and the at least one second client system associated with the at least one second communication sub-network. Thereby two-way packet-based radio transmission of control signals and messages between the at least two client systems associated with at least two radio communications sub-networks is provided.

### BRIEF DESCRIPTION OF THE DRAWINGS

The present invention will be understood and appreciated more fully from the following detailed description taken in conjunction with the drawings in which:

FIG. 1 is a simplified block diagram of an exemplary IPRS system that can be operative in the implementation of the proposed system and method, in accordance with a preferred embodiment of the present invention;

FIG. 2 shows the components constituting the IPRS server application, in accordance with a preferred embodiment of the present invention;

FIG. 3 shows the operative components constituting the IPRS client application, in accordance with a preferred embodiment of the present invention,

FIG. 4 shows an exemplary structure of the proposed system and method in accordance with a preferred embodiment of the present invention; and

FIG. 5 is a simplified block diagram illustrating the hierarchical flow of information across the proposed system, in accordance with a preferred embodiment of the present invention;

FIG. 6 is a simplified block diagram that illustrates exemplary elements associated with the proposed system and method, organized in a hierarchical manner, in accordance with a preferred embodiment of the present invention; and

FIG. 7 is a simplified flowchart that illustrates the user registration process, in accordance with a preferred embodiment of the present invention;

FIG. 8 is a flowchart that illustrates the termination of the connection between a client and the server, in accordance with a preferred embodiment of the present invention;

FIG. 9A is a flowchart illustrating the exchange of messages involved in the connection process between two users, in accordance with a preferred embodiment of the present invention;

FIG. 9B is a graphical illustration of the conceptual path of the messages involved in the connection process, in accordance with a preferred embodiment of the present invention;

FIG. 9C is a flowchart illustrating the exchange of messages involved in the connection process between two users without an IPRS server, in accordance with a preferred embodiment of the present invention;

FIG. 9D is a graphical illustration of the conceptual path of the messages involved in the connection process without an IPRS server, in accordance with a preferred embodiment of the present invention;

FIG. 10A is a simplified flowchart that illustrates the process of communication between within the same radio network utilizing the same server, in accordance with a preferred embodiment of the present invention;

FIG. 10B illustrates graphically the conceptual path of the messages involved the process described in association with FIG. 7A, in accordance with a preferred embodiment of the present invention;

FIG. 11A illustrates graphically the conceptual path of the messages involved the setting up of a communication session between two users associated with separate servers although operating in the same radio network in the first operational mode, in accordance with a preferred embodiment of the present invention;

FIG. 11B illustrates graphically the conceptual path of the messages involved the initiation of a communication between two users associated with the same radio network but listed in different servers in the second operational mode, in accordance with a preferred embodiment of the present invention; and

FIG. 12A illustrates graphically the conceptual path of the messages involved the initiation of a communication between two users associated with two different radio networks and listed in two different servers in a first operational mode, in accordance with a preferred embodiment of the present invention; and

FIG. 12B illustrates graphically the conceptual path of the messages involved the initiation of a communication between two users associated with two different radio networks and listed in two different servers in a second operational mode, in accordance with a preferred embodiment of the present invention;

FIG. 13A illustrates graphically the conceptual path of the messages involved the initiation of a unicast simulating multicast communications session between a single user and a group of N targeted users within a single radio network and listed in a single server, in accordance with a preferred embodiment of the present invention;

FIG. 13B illustrates graphically the conceptual path of the messages involved in the initiation of a unicast simulating multicast communications session between a single user and a group of N targeted users within a single radio network without an IRPS server, in accordance with a preferred embodiment of the present invention;

FIG. 14 is a flowchart that illustrates one functionality of the Multi-point Conference (MC) module, in accordance with a preferred embodiment of the present invention;

FIG. 15 shows a simplified flow chart that illustrates the operation of the Multi-point Conference (MC) in the setting up of an RTP session, in accordance with a preferred embodiment of the present invention;

FIG. 16 illustrates graphically the conceptual path of the messages involved in the communication between two groups of users associated with two different radio networks and listed in two different servers, in accordance with a further preferred embodiment of the present invention; and

FIGS. 17A, 17B, 17C, 18A, 18B, 19A, 19B, 19C, 20A, show exemplary display screens representing various aspects of the client Graphical User Interface (GUI), in accordance with a preferred embodiment of the present invention.

### DETAILED DESCRIPTION OF THE PREFERRED EMBODIMENT

An improved two-way communications network that transmits over a cellular communications network utilizing a packet-based protocol, such as the Internet Protocol (IP) or the X.25 protocol, is disclosed. In addition to the standard intra-network functions the improved like radio network provides advanced functions, such as sophisticated roaming services. The improved two-way like radio network enables the transmission of information across diverse worldwide communications networks running packet-oriented protocols. Thus, a worldwide integration of two-way like radio communications networks is achieved. The information transmitted in the improved radio network is packet-based and capable of transmitting content in diverse formats such as voice, graphics, images, video, data, applications, and the like. The proposed system and method also provides integrated data services including transmission of text messages, e-mail, data communication network access and the like. The roaming service is supported across communications networks that run under the General Packet Radio Service (GPRS) technology, which is based on Global System for Mobile (GSM) communication. The system and method proposed by the present invention will be referred to in the text of this document as the Internet Protocol Radio Service (IPRS). Note should be taken that the name “IPRS” used only as a convenient labeling means and therefore not intended to be a suggested limitation on the system and method described in the following. The limits of the present invention would be defined in the following claims. In the context of the present invention the like radio communications network or messages shall be referred to radio communications network or messages. The reference to radio is made in the context of the present invention and not specifically to traditional radio network. For the ease of understanding of the present invention the term radio is referred to and should not be construed narrowly.

The IPRS network is an improved two-way radio network with substantially enhanced inter-radio-network connectivity options. A subscriber of the IPRS network operates a mobile or fixed radio device. A specifically developed client application operative in the implementation of the proposed system and method is preferably installed in the radio device. The subscriber connects to an IPRS platform associated with a conventional wireless communications network, such as a cellular telephone network. The IPRS platform is a computing and communicating device having a users database and an IPRS process server installed thereon. In another preferred embodiment of the present invention the IPRS platform does not include an IPRS server. Any server functionality which may be related to addressing is obtained from third party servers and otherwise no servers are required to make and use the invention. The users database includes a set of interconnected data structures storing specific information that defines the logical structure of one or more IPRS networks. The information consists of, for example, a list of IPRS network users and the users-related functional information, such as address, status, group membership, quality of service data, and the like. The subscriber connects to the IPRS process server installed on the IPRS platform via an IP packet-oriented communications channel by submitting suitable requests to establish communication with one or more users. The IPRS server may be a third party server to which the user send a query or through which the user sends a message to another user in order to first establish a connection. In the context of the present invention the term IPRS server shall also mean third party server or messaging server according to the context applied. The requested users could be operating the same IPRS network or in any other local or remote IPRS networks. If the requested users are registered on the same IPRS server like the subscriber then the IPRS server establishes an appropriate radio link between the subscriber and the requested users by allocating a suitable communication channel across the same wireless communications network. When the users requested by the subscriber are registered on a different IPRS server installed on a different IPRS platform associated with the same wireless communications network then the IPRS servers establish an appropriate radio link between the subscriber and the requested users by allocating a suitable communication channel across the same wireless communications network. If the users requested by the subscriber are registered on one or more different IPRS servers installed on one or more IPRS platforms associated with one or more remote wireless communications networks, the IPRS server establishes a communications link with the different IPRS servers across the one or more remote wireless networks via appropriate gateway devices. Thus the subscriber is given the option of communicating with users of the same IPRS network defined within the same IPRS server, with users of different IPRS networks defined within the same IPRS server, and with users of different IPRS networks defined on different IPRS servers associated with remote wireless communications networks. Additionally, an IPRS network can be spread out among different wireless communications networks by defining one or more users on IPRS servers of the same IPRS network associated with one wireless communications network, and defining one or more different users of the same IPRS network on different IPRS servers associated with remote wireless communications networks. The proposed system and method provides all the functions of a conventional two-way radio network such as instant connectivity, group calls, private calls, unit-to-unit communications, and the like. The proposed system and method is also operative in providing enhanced content for transmission, dynamically allocated bandwidth, a substantially large number of channels, half-duplex communications, advanced services, and reduced cost.

The proposed system and method provides the option to the clients to select a specific communication mode in which the connection is achieved without an IPRS server. This mode of communication is based on the connection of the clients by using their IP number. The communication is also based on the utilization of a non-IPRS cellular network entity, such as an SMS server, a RADIUS server or a RADIUS gateway that are accessible to the IPRS clients and are having the capability of translating the phone numbers of the clients to the their current IP number. According to such preferred embodiment the user initiating the call may contact the target user directly if the initiating user's cellular device includes the IP address for the target user's cellular device. If the initiating user does not possess such an IP address he may send a message to the target user's cellular device with his own IP. This specific message will instruct the target user's cellular device to initiate an IPRS connection (based on IP) to the initiating user and the communication is completed as both initiating and target users' devices possesses each other IP addresses.

In the preferred embodiment of the present invention the proposed system runs under the Real Time Transport Protocol/Real Time Control Protocol (RTP/RTCP). In other preferred embodiment of the invention other protocols can be used such as the Unix-based Visual Audio Tool (VAT), and the like. In the preferred embodiment of the invention the wireless communications networks utilized as the underlying infrastructure for access, communication, and transmission by the proposed system and method are cellular telephone communications networks running under the GPRS service. In other preferred embodiments of the present invention other pocket-centric transmission technologies could be supported such as Cellular Digital Packet Data (CDPD), Wideband CDMA (WCDMA), and the like.

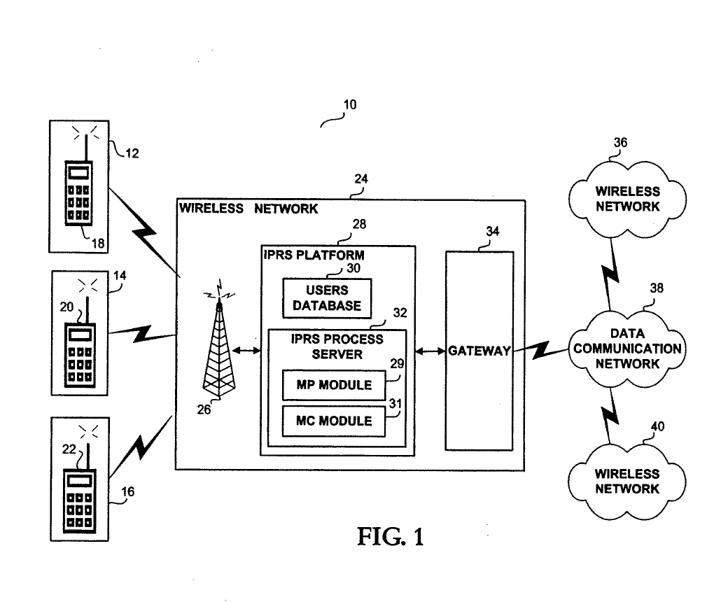

Referring now to FIG. 1 showing a simplified block diagram of an exemplary IPRS system 10 that can be operative in the implementation of the proposed system and method. System 10 includes users 12, 14, 16, a wireless communications network 24, and remote wireless networks 36, 38, and 40. The users 12, 14, 16 are subscribers of a two-way radio communications network designed and implemented according to the preferred embodiment of the present invention. The suitable control information concerning the users 12, 14, 16 and the radio network associated therewith is established on an IPRS computing and communications platform 28 within the wireless communications network 24. The users 12, 14, and 16 operate communication devices 18, 20, and 22, respectively. The communication devices 18, 20, 22 could be conventional mobile cellular devices, Personal Digital Assistants (PDA), personal computers (PC) or any other mobile or stationary device with radio communication capabilities by having suitable radio modem devices installed therein. The devices 18, 20, and 22 also could be specifically modified T/R devices developed originally for use within two-way radio networks. In the preferred embodiment of the present invention the communications devices utilized are IPAQ pocket PCs manufactured by the Compaq Corp, of Houston, Tex., U.S.A. In other preferred embodiments of the present invention diverse other communications devices having basically the same necessary hardware options could be used, such as the Nokia 9210 manufactured by the Nokia Corp., of Keilalandenti, Finland. The IPAQ device runs under the control of the Windows CE operating system while the Nokia 9120 is run via the services of the Symbian operating system. The radio modems installed in the devices could be, for example, the Merlin radio modem manufactured by the Novatel Wireless Inc. of San Diego, Calif., U.S.A. The devices 18, 20, 22 are having the IPRS client application implemented therein to enable the users 12, 14, 16 to access and to communicate with the desired users associated with the same radio network, or with the remote radio networks. The IPRS client application (not shown) includes signaling functions, transport functions, and a user interface. The operation of the IPRS client application will be described hereunder in association with the following drawings. It would be obvious that although only three subscriber devices are shown on the discussed drawing in a realistically configured environment a plurality of subscriber devices could operate within a given radio network. It would be also obvious that the subscribers 12, 14, and 16 could be associated each with a different IPRS network or could be the members of the same IPRS network.

Still referring to FIG. 1 the wireless communications network 24 includes a radio antenna device 26, an IPRS platform 28, and a gateway device 34. The antenna 26 is operative in receiving and transmitting RF signals transmitted and received by the subscriber devices 18, 20, and 22. The antenna 26 is linked to the IPRS platform 28 either via a hard cable or via a radio link. The platform 28 is a computing and communicating device having a memory device (not shown) that stores a users database 28, and an IPRS process server 32. The server 32 includes a Multi-point Conference Module (MC) 29, and a Media Processor module (MP) 31 Note should be taken that only those elements implemented in the IPRS platform 28 are shown that are essential to a ready understanding of the present invention. In a realistic configuration the platform 28 could include a plurality of hardware and software devices essential to the proper operation thereof. Although only a single IPRS platform 28 is shown on the drawing described it would be obvious that in a practical configuration several IPRS platforms could be associated with a single wireless communications network in order to allow for load balancing among the different platforms. Further it is conceivable that a single IPRS platform could be associated with several wireless communications networks. The currently discussed drawing shows a configuration in which the users database 30 and the IPRS process server 32 are co-located on the same computing and communications platform 28. In other possible arrangements the database 30 and the server 32 could be implemented on different devices. The drawing further shows that the MP 29 and the MC 31 are co-located on the same platform 28. In other conceivable configurations the MC 31 and the MP 29 could be implemented on different platforms in order to allow for the optimal sharing of the workload. Thus, an MC 31 could activate simultaneously several MP 29 co-located on the same computing platform with the MC 31 and with each other MPs or installed on different computing platforms. The activation of the several MP 29 could be controlled by a load-balancing server device. Users database 26 is a set of data structures storing information concerning operative IPRS networks, IPRS sub-networks such as groups of users, and the list of users associated with the networks or with the groups of users. The information could include various functional data such as user identification, a user status and the like. A more detailed description of the users database will be set forth hereunder in association with the following drawings. The IPRS server 32 is a set of computer programs specifically developed for the operation of the IPRS system and method. The server 32 is operative in accepting subscribers' request for access and connection, to allocate communication channels, for connecting users, for accessing remote wireless communications networks, and the like. The server 32 includes functional modules such as the MC 31 and the MP 29. The MC 31 is responsible for the signaling functions of the IPRS server while the MP 29 handles the data transport. If a connection request is put through by a subscriber desiring to communicate with a user linked to a remote wireless communications network the server 32 identifies the destination network and instructs the gateway server 34 to connect to the said remote network. The gateway 34 is a computing and communication device operative in connecting different communications networks and translating the information content to the format suitable to the destination network. The wireless network 24 could include more than one gateway devices. Wireless networks 36, 38, and 40 are communications networks utilizing the GPRS service or any other packet-oriented technology. The remote networks 36, 38, 40 include remote IPRS servers (not shown) of their own, having a structure and functionality similar to the structure and functionality of server 32. The gateway device 34 communicates with the remote IPRS servers in order to transmit the subscriber request for communication with the users defined therein. The remote IPRS servers are operative for creating the communication path between the requestor and the requested parties. It would be obvious that although only three remote networks are shown on the discussed drawing in a practical communications environment a plurality of remote networks could be connectable through a plurality of gateway devices in order to provide communication channels between pluralities of users.

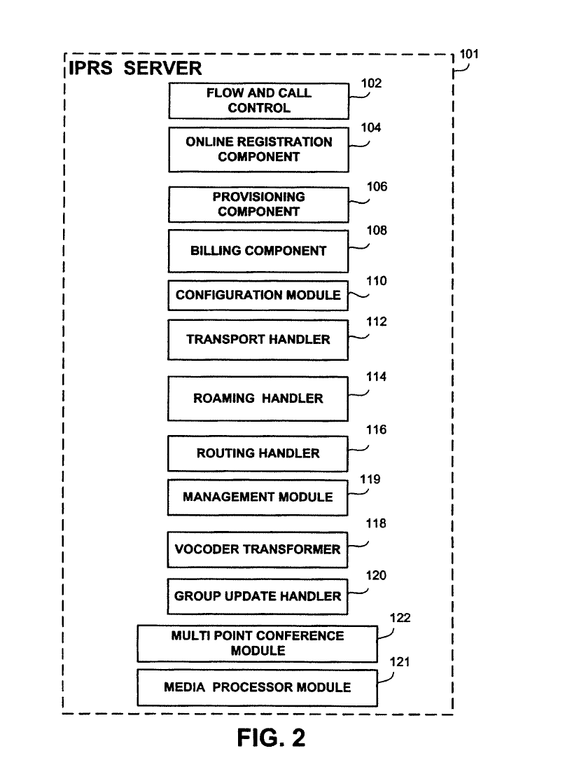

FIG. 2 shows the operative components constituting the IPRS server application 26 of FIG. 1 in accordance with a preferred embodiment of the present invention. The IPRS server 101 may consists of a set of specifically developed software routines stored on the memory device of the IPRS platform 28 of FIG. 1. The IPRS server 101 may also consists of one or more hardware devices such as pre-manufactured integrated circuits or application specific integrated circuits (ASIC) storing a suitable set of built-in machine code instructions functional to the operation of the application. Server 101 includes a flow and call control component 102, an online registration component 104, a provisioning component 106, a billing component 108, a configuration component 110, a transport handler 112, a roaming handler 114, a routing handler 116, a voice coder transformer 118, a group update handler 120, and a management module 119. The main components essential to the operation of the proposed system and method of the present invention are; a multi-point conference (MC) module 122, and a Media Processor Module (MP) 121. The flow and call control component 102 is the main control module of the application. The online registration component communicates with the users desiring to register with the system, terminates existing connections where required, and updates the relevant status flags in the users database. The provisioning component 106 provides customer services, logs transactions, allocates resources, and typically operative in setting up services required by the users. The functionality of the billing component 108 is to provide billing services to the system and to handle the various network-specific or user-specific billing methods (pay-per-session, flat rate, and the like). The configuration component 110 allows for the configuration of the system, such as modifying addresses, user identifications, setting up new radio networks, and the like. The transport handler 112 is responsible for the transmission of the data within the network, the roaming handler 116 controls the channeling of the incoming requests to the suitable networks and accepts and handles the requests of the users associated with remote networks. The voice-coder transformer 118 converts analog speech signals to digital data and via a speech synthesizer converts digital data to artificial speech sounds. The group update handler 120 provides the capability of modifying common group-related parameters of the users. The management module 119 provides the capability to the operators of the IPRS application, to upgrade, to maintain, and to control the operation of the server such as allowing system configuration, database backup/restore, system generation, control table update, and the like.

The multi-point conference (MC) module 122 receives, processes, and forwards the signaling messages between the users of the proposed system. MC module 122 is also operative in instructing the MP module 121 to start a transport session. The MP module 121 is operative in the transfer of the data between the various communicating parties and in transcoding the messages among the different coders/decoders. In other preferred embodiments of the present invention various useful modules could be added to further improve the operation of the proposed system and method and adding supplementary functions.

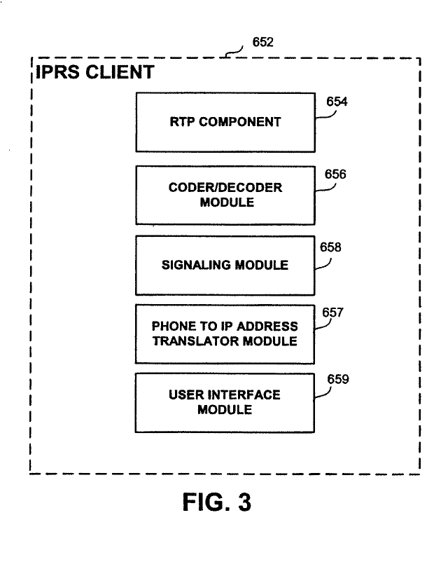

FIG. 3 is a simplified block diagram showing the operative components of the IPRS client application 652. The client application 652 may be a set of software routines specifically developed and stored on the memory device of the subscriber device such as a mobile radio. The application 652 may also be one or more hardware devices such as pre-manufactured integrated circuits of application specific integrated circuits (ASICs) installed on the mobile/fixed radio device and having a set of suitable built in machine code instructions operative in the performance of the application 652. The application 652 includes an RTP module 654, a coder/decoder 656, a signaling module 658, a phone to IP address translator module 657, and a user interface module 659. The RTP module 654 is operative in the running of the Internet Standard Real Time Protocol for the transport of real-time data including audio and video. The RTP is typically used for specific services such as Internet telephony. The coder/decoder (codec) module is responsible for the encoding and decoding of the radio signals. Typically different communications networks, using different communications technologies, implement technology-specific coder/decoder modules. For example in the GSM networks a GSM coder/decoder is implemented, while in the PCS networks a specific. PCS coder/decoder is used. The IPRS server provides transcoding services between the various codecs. Thus, when a user from a GSM-based communications network communicates with a user in a PCS network the appropriate transcoding from the GSM coding/decoding to the PCS coding/decoding technologies is achieved through a suitable routine of the IPRS server. The signaling module 658 is responsible for transmitting requests and associated parameters between the devices or applications to deliver a service request across the networks. The phone to IP address translator module 657 is used when a client communicates without an IPRS server. The module 657 is responsible for connecting the client to a non-IPRS network entity in order to translate a phone number to a valid IP number. The user interface module 659 provides the user of the mobile/fixed radio device with the capability of operating the radio device by receiving and processing the signals delivered from the input devices and input controls such as a pushbuttons, or a microphone installed on the radio device and delivering the incoming messages the output devices such as a speaker or a display screen.

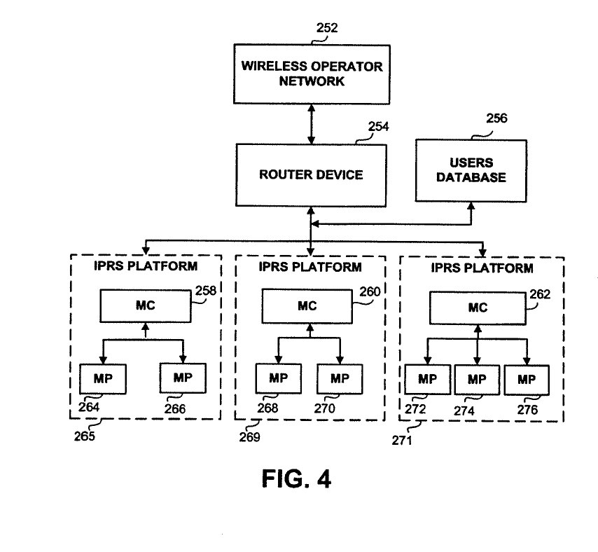

Referring now to FIG. 4 that shows an exemplary structure of the proposed system and method in accordance with a preferred embodiment of the present invention. The system includes a wireless operator network 252 linked to a router device 254. The operator network 252 could be a cellular telephone network. The router device 254 could be a part of the operator network 252 or could be located in a different communications network. The router device 254 is linked to a set of IPRS platforms 265, 269, 271. The IPRS platforms 265, 269, 271 include MC devices 258, 260, and 262, respectively. The MC 258, 260 and 262 are associated with different radio networks. The MC 258, 260, 262 could be installed on separate computing platforms or could be co-located on the same platform. The MC 258 controls MP 264 and 266. The MC 260 controls MP 268, and 270. The MC 262 controls MP 272, 274, and 276. In the proposed system and method the signaling channels are handled by the MC 258, 260, 262 while the RTP channels and the voice/data channels are handled by the MP 264, 266, 268, 270, 272, 274, and 276.

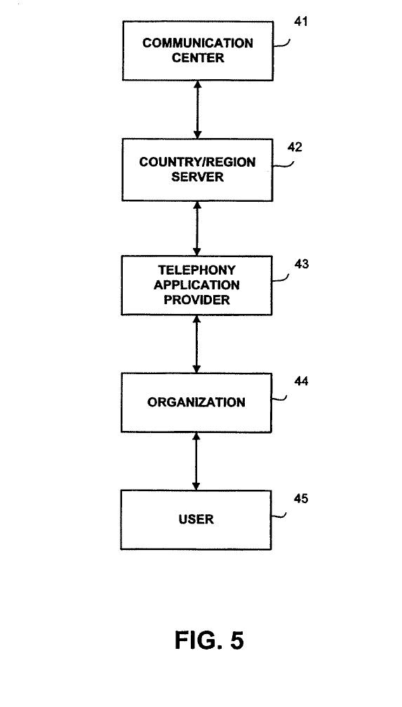

Referring now to FIG. 5, which is a simplified block diagram of the hierarchical configuration of the proposed system, in accordance with the preferred embodiment of the present invention. The system proposed could be distributed and could span the globe. A communication server 41 controls and coordinates the operation of the various servers 42 associated with a specific country or geographical region. The servers 42 control and coordinate the operation of the different telephony application provider servers 43. The servers 43 are typically configured and provided with the functionality of the server 26 of FIG. 1. The server 43 are operative in controlling and coordinating the operation of the various organizations having an associated two-way radio network operational and defined on the servers 43 or on the servers of the organizations. The users 45 are associated with a specific organization 44 and operative information concerning the users is established on the telephony application server 43 in association with the information concerning the radio networks of the organizations 44 or on the servers of the organizations 44.

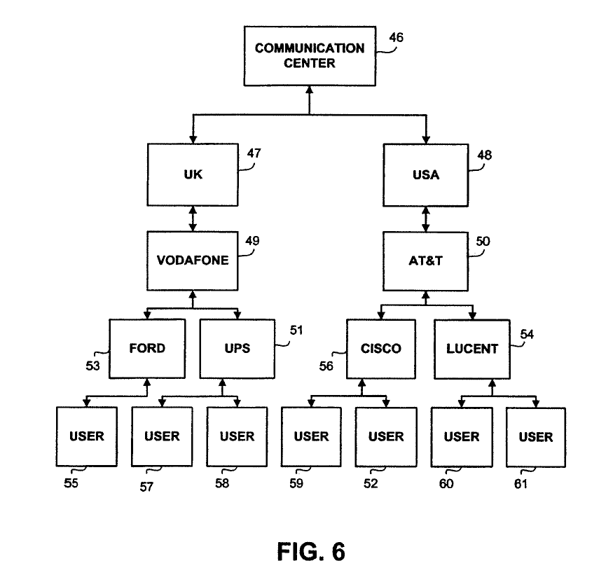

Referring now to FIG. 6 showing a simplified block diagram illustrating an exemplary set of elements organized in a hierarchical manner that are associated with the proposed system and method in accordance with a preferred embodiment of the present invention. Communication center 46 controls and coordinates the operation of the regional servers 48, and 47 located in or are associated with the USA and the UK, respectively. The regional server 48 that is located or associated with the USA region is operative in controlling and coordinating the operation of the telephony application provider 50. The application provider 50 for example is the AT&T Company. One or more IPRS server s of the provider 50 control and coordinate the communications of the organizations 52. The organization 52 is for example Lucent Inc, and Cisco Inc., respectively The Lucent organization 54 includes the associated users 60, 61 that operate within the radio network of the organization 54. The Cisco organization 56 includes the associated users 59, 52 that are subscribers in the radio network controlled by the organization 56. Similarly the regional server 47 that is located or associated with the UK region is operative in controlling and coordinating the operation of the telephony application provider 49. The application provider 49 for example is the Vodafone Corp. of Manchester, UK. One or more IPRS servers of the provider 49 control and coordinate the communications of the organizations 51, and 53. The organizations 51 and 55 are for example the UPS Inc. and the Ford Company, respectively. The UPS organization 51 provides communications capabilities to the associated users 57, 58, while the Ford organization provides communication services to a user 55. It will be obvious that in contrast to the simplified block diagram shown on the discussed drawing in a realistic environment a plurality of application providers could be controlling a plurality of networks operative in providing communications services to a plurality of users therein.

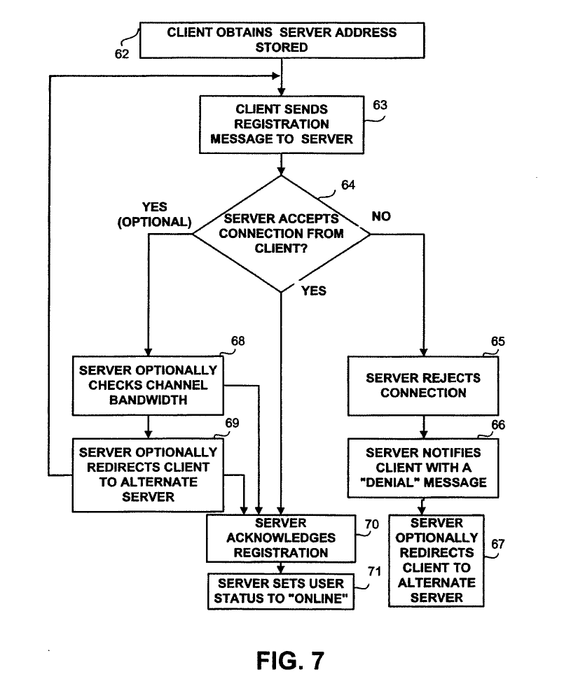

Referring now to FIG. 7 that illustrates the user registration process via a simplified flow chart, in accordance with the preferred embodiment of the present invention. When a subscriber activates the IPRS client application implemented in the user radio device the activation can be made in two differing modes: a) the radio device is activated in the radio network the subscriber is associated with b) the radio device is activated in the roaming mode. When the radio device is activated in the local radio network the device receives an IP address stored within the radio device of the IPRS server storing the radio network information. Subsequently, the IPRS client application initiates a connection to the IPRS server via an IP-packet channel in accordance with the stored IP address. At step 62 the IPRS client obtains the IPRS server address and additional data. The address is an IP address obtained from a Domain Name Server (DNS). The additional data could the port number of the IPRS server, optionally a private key for encryption, the user identification, and the user password. The IPRS client transmits a registration message to the IPRS server at step 63. The registration message is accompanied by other data such as the optional private key, the user identification, the password, and the like. At step 64 it is determined whether the server accepts the connection from the client. If the server does not accept the connection following the recognition of an unauthorized access attempt, errors in the identification, or any other relevant reason then at step 65 the server rejects the connection and at step 66 a suitable notification message, such as a “denied” message, is sent to the client concerning the reason for the denial of the registration. Optionally the server redirects the client to an alternative server to enable an additional attempt of registration (step 67). The “denied” message includes an appropriate error code and a detailed text to be displayed to the initiating user. In contrast, if at step 64 it is determined that the server accepts the connection then at step 70 a message acknowledging registration is sent by the server to the client. At step 71 the server sets the status of the user record stored in the users database to “online”. Optionally at step 68 the server checks the available channel bandwidth and at step 69 the server optionally redirects the client to an alternative server to provide for the allocation of a channel with sufficient bandwidth.

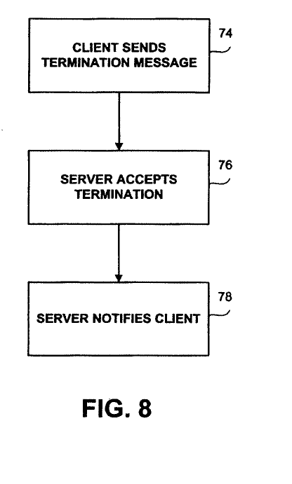

The registration process establishes a connection between the IPRS client and the IPRS server. The connection can be terminated by the server as a result of the timing out of a timer device or the connection can be terminated by the client. Referring now to FIG. 8 that illustrates the termination of the connection between the client and the server via a simplified flowchart in accordance with a preferred embodiment of the present invention. At step 74 the client sends a termination message to the server. At step 76 the server receives and accepts the termination message. At step 78 the client is notified concerning the termination of the connection.

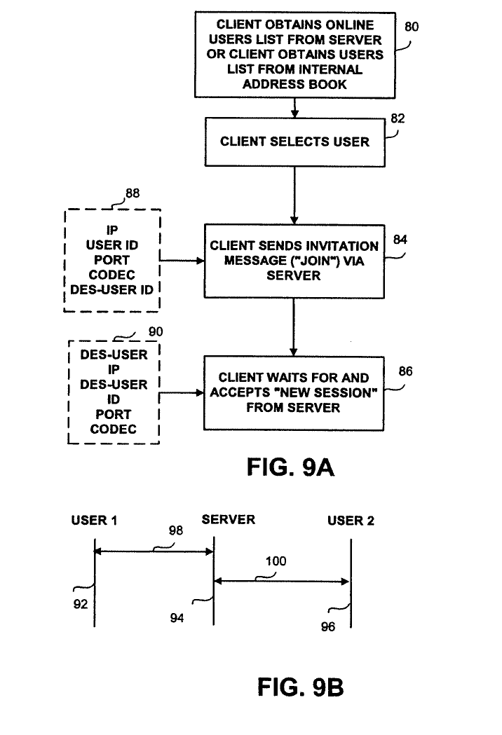

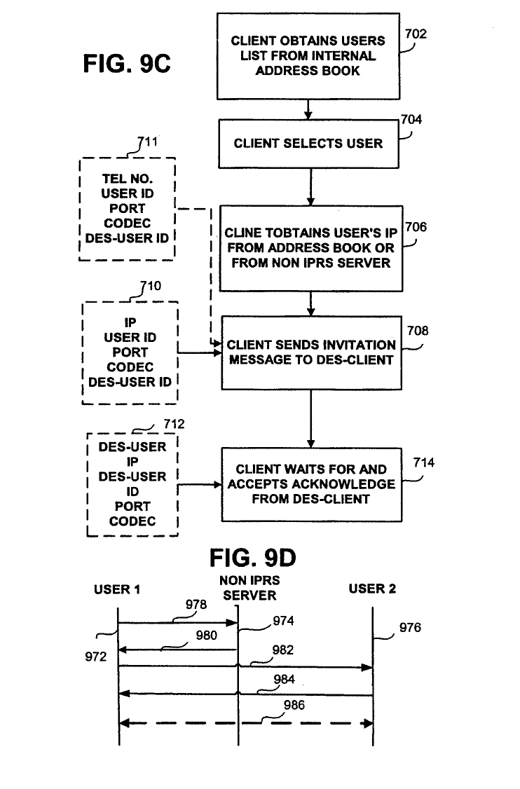

FIG. 9A shows the initiation of a connection from to a client to a specific user. At step 80 the client application obtains the list of users with the “online” status from the user's database 30 of FIG. 1. The client could also use an internal address book with a list of stored users. In this case some of the users may not be online. At step 82 the clients selects a user to communicate with and at step 84 the client transmits an invitation or “join” message to the server with relevant data 88, such as the user identification, user EP, port, coder/decoder routine, and the identification of the requested user. The requested user will be referred to as DES-user in the following text. At step 86 the client waits for and accepts a “new session” message from the server. The message is received with relevant control data 90 such as DES-user IP address, DES-user identification, port, and coder/decoder routine name.

FIG. 9B illustrates graphically the conceptual path of the messages involved the above described process. User 1 (92) transmits an invitation (“join”) message 98 to the server 94. The server 94 checks the status of the user 2 (96) and transmits an invitation (“join”) message 98 to the server 94. The server 94 checks the status of user 2 (96) and sends a new session message 100 to user 2 (96) and another new session message 100 user 2 (96) another new session message (98) to user 1 (92). Both users reply by sending an acknowledgement message to the server 94.

FIG. 9C shows the initiation of a connection from a client to a specific user. At step 702 the client application obtains the list of users from the client internal address book or allows the user to type a user identification manually. At step 704 the clients selects a user to communicate with and at step 706 the client resolves the destination client IP address. Such resolving can be accomplished by looking up the destination client IP address in the user's client internal address book or within the user's client phone. Alternatively the destination client IP resolving can be accomplished by accessing a non IPRS server which is part of the cellular network. At step 708 the client transmits an “invitation” message to the destination client (The requested destination will be referred to as DES-client in the following text) with relevant data 710 or with relevant data 711, such as the user identification, user IP or user telephone number, port, coder/decoder routine, and the identification of the requested user. When the destination user's IP address is known, the invitation may be accomplished via direct link to the destination user. The requested user will be referred to as DES-user in the following text. At step 714 the client waits for and accepts an acknowledgement message from the DES-client. The message is received with relevant control data 712 such as DES-user IP address, DES-user identification, port, and coder/decoder routine name. In an alternative mode when the DES-user's IP address is not known the DES-user's telephone number is used to send the DES-user a message (for example through an SMS or the like or through any other service). Such message includes the client's IP address. When the DES-user receives the particular message with the client IP address the DES-user initiates a connection with the client. The client may receive an acknowledgment 714 with information 712 (which includes the IP of the DES-user) directly or a full connection may be established by the DES-user with the information 712.

FIG. 9D illustrates graphically the conceptual path of the messages involved the above described process. User 1 (972) transmits an “IP resolution request” message 978 to the non-IPRS server 974. The server 974 replies by “IP resolution response” message 980 to user 1 (972). User 1 (972) transmits an invitation (“join”) message 982 to user 2 (976). User 2 (976) replies by sending a “new session” message 984 to user 1 (972). Consequently an RTP session 986 can be started between user 1 (972) and user 2 (976).

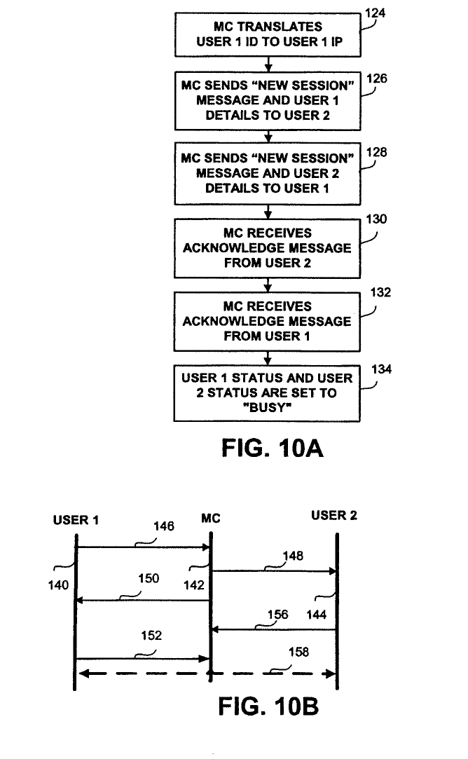

FIG. 10A is a simplified flowchart that illustrates the process of invitation (“join”) communication from a specific user to another user where both users are associated with the same radio network and the same IPRS server. At step 124 the MC module 122 of FIG. 2 translates the user 1 (initiating user) identification to the user 1 IP address. At step 126 the MC sends a session initiation (“new message”) message with the user 1-related data to the user 2 (requested user). At step 128 the MC sends a session initiation (“new session”) message with the user 2-related data to the user 1 (initiating user). At step 130 the MC receives acknowledgment message from user 2 with the relevant control data. At step 132 the MC receives acknowledgment message from the user 1 with the control data. At step 134 the user 1 and user 2 status flags in the users database is set to “busy”.

FIG. 10B illustrates graphically the conceptual path of the messages involved the above described process. User 1 (140) transmits an invitation message (“join”) 146 to the MC module 142. The MC 142 sends a session initiation (“new session”) message 148 to the user 2 (144) and simultaneously sends a session initiation (“new session”) message 150 to user 1 (140). User 2 (144) replies to the session initiation message by sending an acknowledgement message 156 to the MC 142 and user 1 (140) replies to the session initiation message by sending an acknowledgement message 152 to the MC 142. Consequently an RTP session 158 can be started between user 1 (140) and user 2 (144) directly between the two users or via the MC 142.

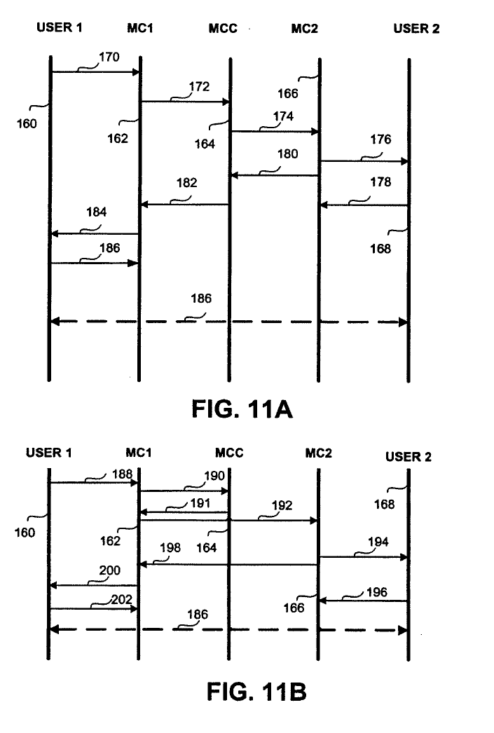

FIG. 11A illustrates graphically the conceptual path of the messages involved the initiation of a communication between two users associated with the same radio network but listed in different IPRS servers in a first mode of an operation. In the first mode of the operation the IPRS servers of the same network communicate via the multi-point conference module of a higher-level IPRS server referred to as the Multi-point Conference Controller (MCC). User 1 (160) transmits an invitation (“join”) message (170) to the MC1 module 162. The MC1 (162) forwards the invitation message 172 to the MCC 164. The MCC 164 is an MC module implemented in a higher-level IPRS server that controls and coordinates the operation of the lower level IPRS servers. The MCC 164 forwards the invitation message 174 to an MC2 module (166) implemented in the IPRS server of the remote wireless network. The MC2 (166) sends session initiation (“new session”) message 176 to the user 2 (168). The MC2 (166) also sends a session initiation (“new session”) message 180 to the MCC (164). The MCC forwards 182 the message to the MC1 (162), which forwards 184 it to the user 1 (160). User 2 (168) replies to the session initiation message by sending an acknowledgement message 178 to the MC2 (166), User 1 (160) replies to the session initiation message by sending an acknowledgement message 186 to the MC1 (162). More acknowledgement messages may be forwarded between the MCs (not shown). Consequently an RTP session 186 can start between the user 1 (160) and the user 2 (168).

FIG. 11B illustrates graphically the conceptual path of the messages involved the initiation of a communication between two users associated with the same IPRS network but listed in different IPRS servers, according to the second mode of operation. In the second mode of the operation the communication between the IPRS servers of the different networks is accomplished by a specific “location” function. Thus, user 1 (160) transmits an invitation (“join”) message 188 to the MC1 module 162. The MC1 (162) interrogates 190 the MCC 164 concerning the address of the MC2 (166). The MCC 164 provides 191 the address of the MC2 (166) to the MC1 (162) that consequently forwards the invitation (“join”) message 192 directly to the MC2 (166). The MC2 (166) sends session initiation (“new session”) message 194 to the user 2 (168). The MC2 (166) also sends a session initiation (“new session”) message 198 to the MC1 (162), which forwards 200 it to the user 1 (160). User 2 (168) replies to the session initiation message by sending an acknowledgement message 196 to the MC2 (166), User 1 (160) replies to the session initiation message by sending an acknowledgement message 202 to the MC1 (162). More acknowledgement messages may be forwarded between the MCs (not shown). Consequently an RTP session 186 can be started between the user 1 (160) and the user 2 (168).

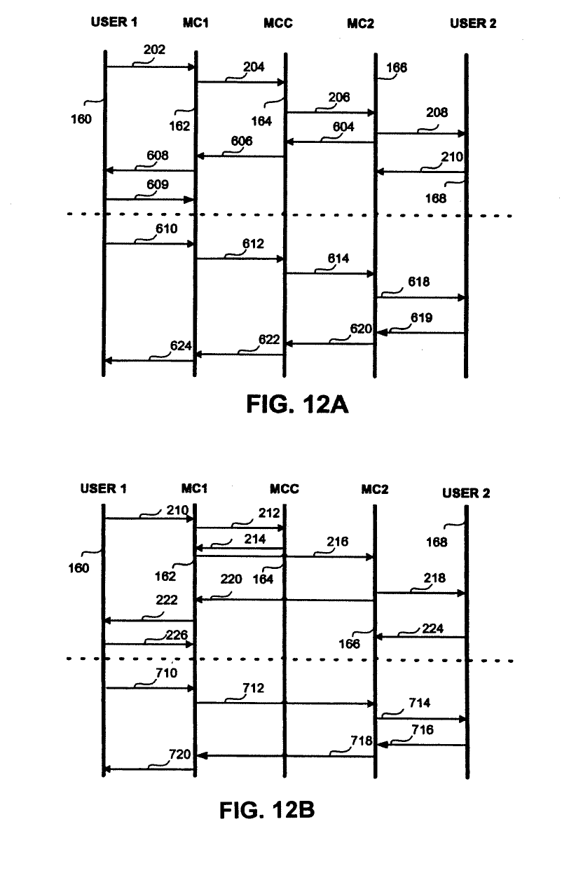

FIG. 12A illustrates graphically the conceptual path of the messages involved the initiation of a communication between two users associated with two different IPRS networks and listed in two different IPRS servers. In the first mode of the operation the communication between the IPRS servers of the different IPRS networks is accomplished via the high-level multi-point conference module MCC. Thus, user 1 (160) transmits an invitation (“join”) message 202 to the MC1 module (162). The MC1 (162) forwards the invitation message 204 to the MCC 164. The MCC 164 forwards the invitation message 206 to the MC2 (166). The MC2 (166) sends session initiation (“new session”) message 208 to the user 2 (168). The MC2 (166) also sends a session initiation (“new session”) message 604 to the MCC (164). The MCC forwards 606 the message to the MC1 (162), which forwards 608 it to the user 1 (160). User 2 (168) replies to the session initiation message by sending an acknowledgement message 219 to the MC2 (166), User 1 (160) replies to the session initiation message by sending an acknowledgement message 609 to the MC1 (162). More acknowledgement messages may be forwarded between the MCs (not shown). Consequently an RTP session can be started between user 1 (160) and user 2 (168) via the MC1 (162), the MCC 164, and the MC2 (166). The user 1 (160) communicates data 610 to the MC1 (162). The MC1 (162) forwards 612 the data to the MCC (164), which in turn forwards 614 the data to MC2 (166). The MC2 (166) transmits 618 the data to the user 2 (168). The return path of communication from the user 2 (166) via MC2 (166), the MCC 164, the MC1 (162) to the user 1 (160) shown as 619, 620, 622, and 624 respectively.

FIG. 12B illustrates graphically the conceptual path of the messages involved the initiation of a communication between two users associated with two different radio networks and listed in two different IPRS servers. In the second mode of the operation the communication between the IPRS servers of the different networks is accomplished via the specific “locate” function. Thus, user 1 (160) transmits an invitation (“join”) message 210 to the MC1 module (162). The MC1 (162) interrogates 212 the MCC 164 in regard to the address of the MC2 (166) and subsequent to the received address 214 forwards 216 the invitation message 212 directly to the MC2 (166). The MC2 (166) sends session initiation (“new session”) message 218 to the user 2 (168). The MC2 (166) also sends a session initiation (“new session”) message 220 to the MC1 (162), which forwards 222 it to the user 1 (160). User 2 (168) replies to the session initiation message by sending an acknowledgement message 224 to the MC2 (166), User 1 (160) replies to the session initiation message by sending an acknowledgement message 226 to the MC1 (162). More acknowledgement messages may be forwarded between the MCs (not shown). Consequently an RTP session can be started between user 1 (160) and user 2 (168) via the MC1 (162) and the MC2 (166). The user 1 (160) communicates data 710 to the MC1 (162). The MC1 (162) forwards 712 the data to the MC2 (166). The MC2 (166) transmits 714 the data to the user 2 (168). The return path of communication from the user 2 (166) via MC2 (166), the MC1 (162) to the user 1 (160) is shown as 716, 718, and 720 respectively.

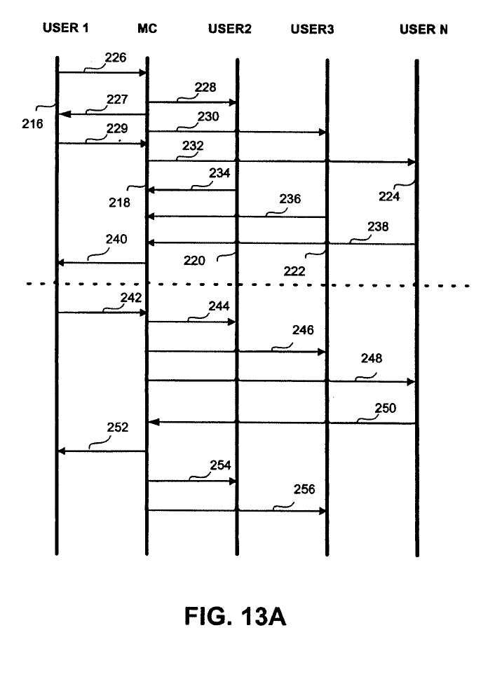

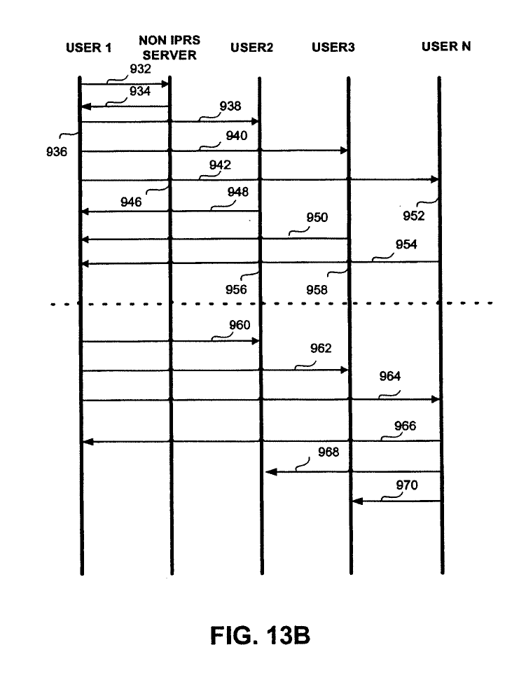

FIG. 13A illustrates graphically the conceptual path of the messages involved the initiation of a unicast-simulating-multicast communication session between a single user and either a specific group of users or a set of N targeted users within a single IPRS network and listed in a single IPRS server. User 1 (216) sends an invitation (“join”) message 226 to the MC 218. The data with the message includes data concerning either a specific group of users or a set of individual users. The data includes addresses referring either to the group of users or to the set of the N users that user 1 (216) is desired to communicate with in the framework of a single session. Thus, the MC 218 processes the invitation message 226 and as a result the MC 218 forwards N−1 identical session initiation (“new session”) messages with suitable addresses and data 228, 230, and 232 to user 2 (220), user 3 (222), and to user N (224), respectively. The MC 218 also sends a session initiation (“new session”) message 227 to user 1 (216). Optionally user 1 (216) returns acknowledgement message 229. Optionally each of the N−1 users replies with an acknowledgment message to the MC 218. User 2 (220) returns acknowledgement message 234, user 3 (222) returns acknowledgement message 236, and user N (224) returns acknowledgement message 238. Optionally the MC 218 processes the entire set of received acknowledgement messages and forwards a suitable set of acknowledgment messages 240 back to user 1 (216). Note should be taken that the set of the messages 242 includes only received acknowledgements. If, for example, user 3 (222) does not replies then the set of the messages 240 will include messages from the user 2 (220) and the user N (224) only. Consequently user 1 (216) initiates an RTP session and transmits a set of suitable data messages 242 to MC 218. The MC 218 processes the set of data messages and forwards N−1 resulting messages 244, 246, and 248 to the N targeted users 220, 222, 224, respectively. Consequentially an answering data message 250 from one of the users, say user N 224 is received by the MC 218 that in turn processes the answering message and forwards N resulting messages 252, 254, and 256 to the N targeted users 216, 220, 222.

FIG. 13B illustrates graphically the conceptual path of the messages involved the initiation of a unicast-simulating-multicast communication session between a single user and a set of N targeted users within a single IPRS network. User 1 (936) transmits an “IP resolution request” message 932 to the non-IPRS server 946 with request to resolves the addresses of users 2 to user N. The server 946 replies by “IP resolution response” message 934 to user 1 (936). User 1 (936) sends N−1 identical invitation (“join”) messages with suitable addresses and data 938, 940, and 942 to user 2 (956), user 3 (958), and to user N (952), respectively. Each of the N−1 users replies with a “new session” message to user 1 (936). User 2 (956) returns “new session” message 948, user 3 (958) returns “new session” message 950, and user N (952) returns “new session” message 954. Optionally, user 1 returns N−1 acknowledgement messages to user 2 up to user N (not shown). Consequently user 1 (936) initiates an RTP session and transmits a set of N−1 messages 960, 962, and 964 to the N−1 targeted users 956, 958 and 952, respectively. Consequentially a specific answering data messages 966, 968, or 970 from one of the users, say user N 952 is transmitted to the N−1 targeted users 936, 956, and 958, respectively.

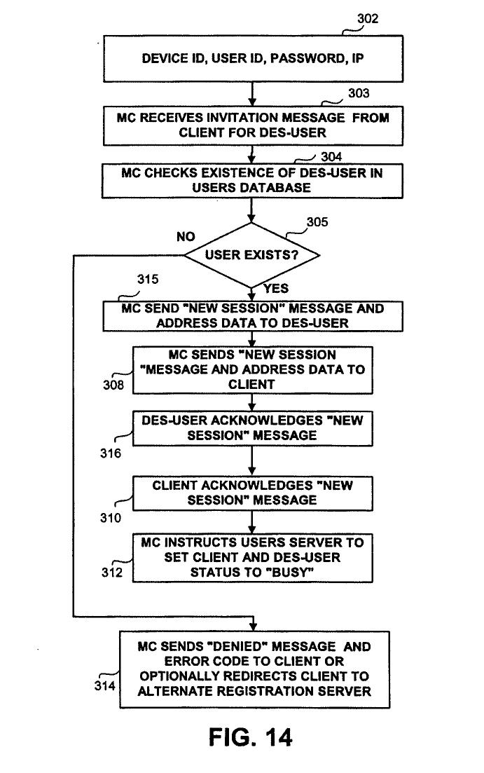

Referring now to FIG. 14 illustrating the functionality of the MC module via a simplified flowchart of the user session initiation process performed by the MC module, in accordance with a preferred embodiment of the present invention. At step 303 the MC receives an invitation message from an IPRS client concerning the opening of a channel to a DES-user. The invitation message includes important control information 302, such as device identification, user identification, user password, IP, and the like. At step 304 the MC accesses the users database in order to check for the existence of the DES-user in the database. At step 305 it is determined whether the user is defined in the user database. If the result is negative then at step 314 the MC sends a “denied” message with attached error code to the IPRS client device, which initiated the connection. Optionally, the MC could redirect the IPRS client to an alternative IPRS registration server. If at step 305 it is determined that the DES-user is listed in the users database then at step 315 the MC sends a “new Session” message with attached client address and identification data to the DES-user. At step 308 the MC sends a “new Session” message with attached DES-user address and identification data to the client device. At step 316 the DES-user acknowledges the “New Session” message and at step 310 the client acknowledges the “New Session” message. At step 312 the MC instructs the users database to set the initiating client device and the DES-user device statuses to “busy”. The MC is further operative in the activation of a timer device. The timer is active as long as the communications channel between the IPRS clients is active. When the channel is idle after a period having a predefined length the connection is torn down.

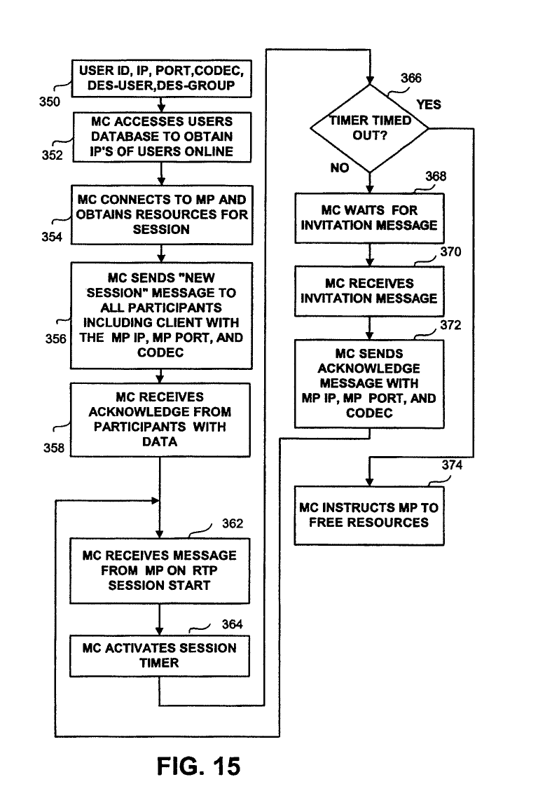

FIG. 15 shows a simplified flow chart that illustrates the operation of the MC in the setting up of an RTP session to be utilized for the transmission of voice/data stream between an initiating IPRS client and either a requested user (DES-user) or a specific group of requested users referred to as the DES-group. The MC provides the option of handling and processing of a plurality of RTP sessions initiated by a plurality of clients substantially simultaneously. The initiating user sends an invitation (“join”) message designed to effect the start of an RTP session. The message includes important operative data 350, such as user identification, user IP, port number, coder/decoder module name, DES-user identification, DES-group, and the like. At step 352 the MC accesses the users database in order to obtain the IP addresses of the users with the “online” status. At step 354 the MC instructs the MP to allocate resources for the RTP session. At step 356 the MC connects to the MP and obtains resources for the RTP session. At step 356 the MC sends “New Session” messages to all the DES-users or DES-groups and client participating in the session. The messages include important operational data such as MP IP, MP port number, coder/decoder module name, and the like. At step 358 the MC receives acknowledgement messages from the entire set of participating DES-users or DES-groups and client where the messages include address and identification data. At step 362 the MC receives an RTP session start message from the MP. At step 364 the session timer is activated in order to disconnect the session after a predefined number of seconds if the communications channel is idle. At step 366 it is checked whether the session timer had timed out. If the timer is timed out then at step 374 the MC instructs the MP to free the resources allocated for the session. As long as the timer is running the MC waits for new invitation (“join”) messages (step 368). At step 370 the MC receives an invitation message and consequently sends an “New Session” message including the MP IP, port number, coder/decoder module name, and the like (step 372). Subsequently program control proceeds to step 362 and a program loop is activated across steps 362 through 374. The loop is executed repeatedly during the timer's active period.

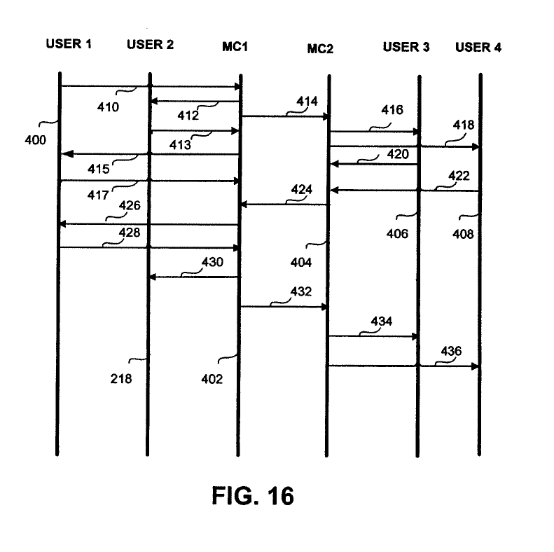

FIG. 16 illustrates graphically the conceptual path of the messages involved in the communication between two groups of users associated with two different IPRS networks and listed in two different IPRS servers. User 1 (400) transmits an invitation (“join) message 410 to the MC1 module 402. The MC1 (402) sends a session initiation (“new session”) messages 412 and 413 to the user 2 (218) and to the user 1 (400) respectively. The MC1 (402) also forwards the invitation message 414 to the MC2 (404). The MC2 (404) sends session initiation (“new session”) messages 416 and 418 to the user 3 (406) and to the user 4 (408), respectively. The user 2 (218) and the user 1 (400) respond by returning acknowledgement messages 413 and 417 to the MC1 (402), respectively. The user 3 (406), and the user 4 (408) both return acknowledgement messages 420, and 422, respectively to the MC2 (404). The MC2 (404) forwards a suitable set of acknowledgment messages 424 to the MC1 (402). The MC1 (402) forwards a set of acknowledgement messages 426 to the user 1 (400). More sets of acknowledgement messages may be forwarded between MC1 and MC2, MC1 and user 1 and user 2, MC2 and user 3 and user 4, but they are not shown here. Consequently the user 1 (400) starts an RTP session by transmitting a voice/data message (428) to the MC1 (402). The MC1 (402) forwards the voice/data message 430 to the user 2 (218) and forwards a set of messages 432 to the MC2 (404), that in turn forwards the voice/data messages 434, and 436 to the user 3 (406), and the user 4 (408) respectively. The graphical user interface (GUI) of the IPRS client application will be described next. The description will include the main part of the program flow and the functionality of the program at each step. The description will be given in association with the following drawings.

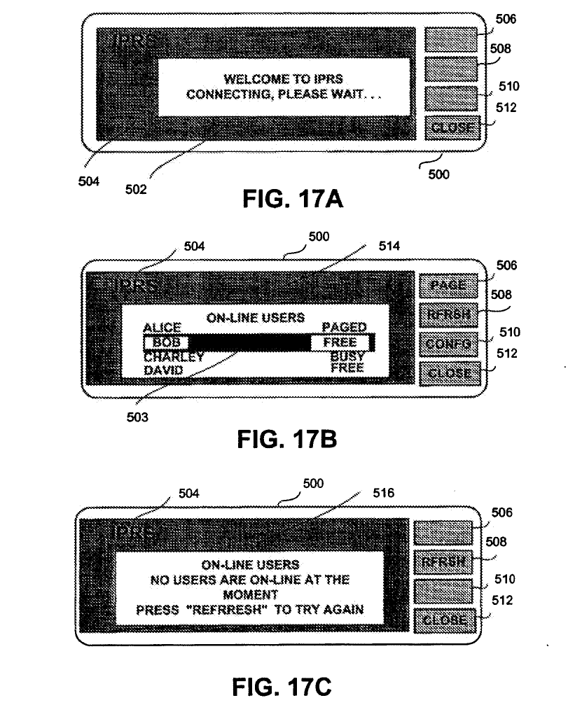

Referring now to FIG. 17A that shows the initial display screen of the IPRS client application. Display screen 500 is part of the mobile or fixed user wireless device. The device could be a standard mobile cellular phone, a PDA, a PC, or any other computing and communicating device having a memory device and basic communications capabilities. The display screen 500 could utilize Liquid Crystal Display (LCD) technology or any other method operative in displaying text, graphic, images, and the like. The user wireless device is also equipped with voice communications interface units (not shown) such as at least one speaker device, a microphone device, and the like. On the surface area of the display device 500 various known GUI-related graphical elements, such as windows, buttons, and selections bars are displayed. Thus, on the surface of device 500 the display includes a main application screen window 504 including the title of the IPRS application, an initial window 502 including “welcoming” text, and a set of control buttons 506, 508, 510, 512. The functions of the control buttons 506, 508, 510, and 512 is changeable across the various windows displayed to the operating user before, during, and subsequent the communication session. Consequently the control buttons 506, 508, 510, and 512 are labeled in diverse changeable text where the labels displayed refer to the current function of a specific button. The user can interface with the displayed windows by manipulating standard function keys (not shown), which are commonly available and typically installed on a keypad area of the mobile or fixed wireless user device. For example, to select a control button for operation a specific key, such as the “up-arrow key” could be used, and in order to activate the selected button the “Yes” key could be utilized. During the display of the initial window only the control button 512 labeled as “Close” is functional. Thus, selecting and activating the close control button 512 will terminate the IPRS application. The initial window 502 is displayed when the client program is first activated or any time before the list of the online users displayed or refreshed. The welcome sentence displayed on the initial window 502 appears only on program load or when the initial screen is first displayed. During the display period of the initial screen 502 the IPRS client program performs a logon to the IPRS server. If the logon to the server is performed for the first time a configuration window is displayed, which will be described in association with the following drawings. Note should be taken that the IRPS client could be working without an IPRS server as described hereinabove in association with the FIGS. 9C, 9D and 13B.

Subsequent to the completion of a successful connection between the client program and the server the client program obtains the list of the users with the “online” status. Optionally, the client program could also obtain a list of groups. When working without an IPRS server the list of users is taken from the internal address book of the client where status of the users is unknown. FIG. 17B shows online users list window displayed to the initiating user. The display screen 500 consists of main application window 504 labeled with the client program name, the online users list window 514, a selection bar 503, and the control buttons 506, 508, 510, and 512. The online users list window 514 includes text indicating the names of the set of online users with associated information, such as “paged”, “free”, “busy”, and the like. The selection bar 503 is operative in enabling the initiating user to select a specific online user in order to initiate a communication session therewith. The selection bar is manipulated through the activation of a predefined function key on the mobile wireless unit, such as the “up-arrow” key, and the “down-arrow key”. By repeatedly pressing one of the above mentioned function keys the selection bar moves from one online user name to the next name. The calling of a selected user is effected by the selection and activation of the control button 506 that is appropriately labeled as “Page” during the display of the window 514. The control button 508 optionally labeled as “Rfrsh” to provide the refreshing of the display within the online users list window 514. The selection and activation of the control button 510 labeled as “Confg” is operative in the loading of the Configuration window that will be described hereunder in association with the following drawings. The function of the control button 512 labeled as “Close” is to terminate the IPRS client application, to free all the system resources allocated to the communication session and tear down the connection between the client device and the IPRS server. For example, in the 514 window the text informs the user that Alice, Bob, Charley, and David are online users. Alice is talking with one person and may accept call waiting. Charley is talking with two persons. Bob and Alice are not talking. Bob is selected by the selection bar 503. Activating the “Page” control button 506 will initiate an attempt to create a connection to Bob. The selection bar 503 will stay on the last person the initiating user communicated with or tried to create a connection with.

If no users listed on the server with “online” status then the client application receives appropriate information from the server. FIG. 17C shows the online users list window 516 indicating an empty list of online users with a notification message displayed in the window 516 along with suitable instructions concerning the continuation of the session. For example, the text could optionally include the instruction “Press refresh to try again”. The control button 508 labeled “Rfrsh” is optionally operative instructing the program to access the server again and attempt to obtain a preferably updated list of the online users. The “Close” control button 512 is operative in terminating the application, freeing the allocated resources and in tearing down the communication link between the user and the server. Typically selecting and activating the “close” control button 512 at any time during the operation of the program will instantly abort the connection and terminate the program.

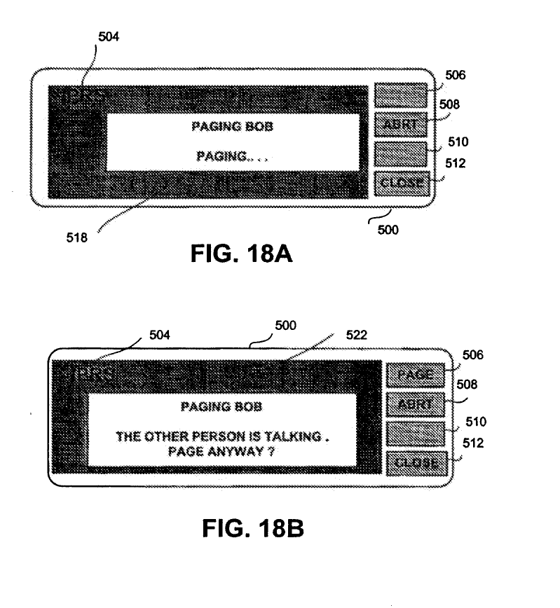

FIG. 18A shows the paging attempt window. The paging attempt window 516 is displayed when a paging attempt is made to another user. The name of the user called is displayed on the top of the window 516. Selecting and activating the “Abrt” control button 508 will abort the paging and the program will display the online users list window 514 with the associated control buttons. If the user paged is talking the prompt to page waiting window will be displayed. If the user called is busy the busy screen will be displayed.

FIG. 18B shows the prompt to page waiting window 522. The window 522 informs the initiating user that the other person is being paged by a third party and inquires the initiating user whether a page waiting should be performed. If the initiating user chooses not to disturb the user called then the “Abrt” control button 508 is selected and activated. Activating the “Page” control button 506 will place a call effecting a page waiting situation at the user called. Optionally a timeout feature could be added to the client program. The timeout routine will abort the call after a time period having a predefined length.

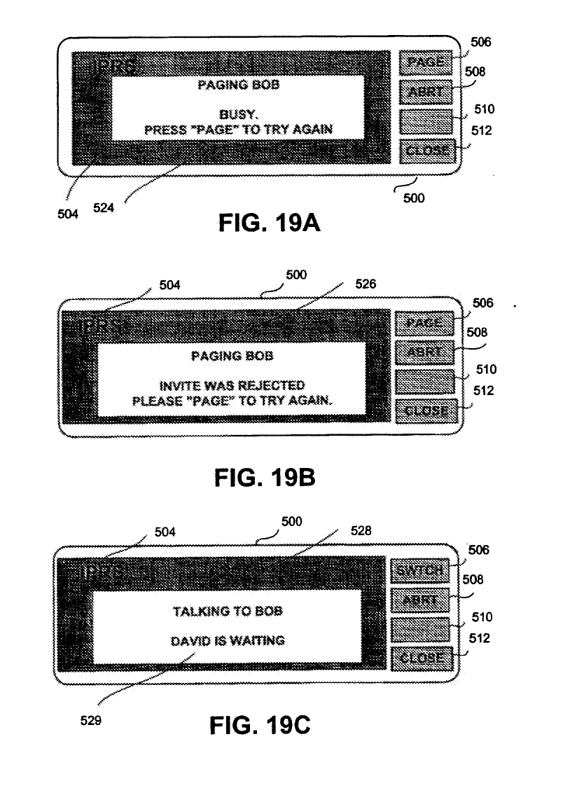

If the user called is busy by talking to at least two other users the busy window is displayed to the initiating user. FIG. 19A shows the busy window 524. Selecting and activating the “Page” control button 506 will initiate an attempt to page the user again. The “Abrt” call button 508 will abort the connection attempt, and will re-display the initial window 502 of FIG. 17A.

If the user paged rejects the inviting message the reject message e window will be displayed to the initiating user. FIG. 19B shows the rejected message window 526. In order to try and initiate the paging again the “page” control button 506 should be selected and activated. To abort the call attempt and re-display the initial window 502 of FIG. 17A the “Abrt” control button 508 should be activated.

Subsequent to the establishment of a connection between two users a voice transmission could be performed by pressing a predefined function key installed on the client device. The function key that is defined for this purpose could be any of the standard keys available, such as the Press to Talk (PTT) key, the space bar, and the like. FIG. 19C shows the talk mode window 528, which is displayed with the associated control buttons 506, 508, 510, and 512 for the duration of an established communication session between the users. The name of the connected user is displayed within the talk mode window 528. If a third party is waiting a message 529 containing the name thereof will be displayed beneath the message indicating the ongoing paging with the original user called. The message 529 may be displayed in a specific graphic mode such as a blinking text or a colored text. To switch the paging from the originally called user to the waiting third party or switch the paging back to the originally called user the “Swtch” control button 506 should be selected and activated. The “Abrt” control button 508 will terminate the connection and abort the paging. If a third party is waiting the paging be automatically switched thereto. The same effect is achieved if the another user terminates the paging. If the user waiting aborts then the waiting message 529 thereof will be deleted from the window 528. If the user with whom the call is established switches to another call the waiting window (not shown) will be displayed to the initiating user within which the message “Talking to XXX” will be replaced by the message “Waiting for XXX”. The text of the message could be optionally in a specific graphic mode, such as blinking text or differently colored characters. If only one user is connected and an another paging is received, the page waiting window will be displayed to the initiating user.

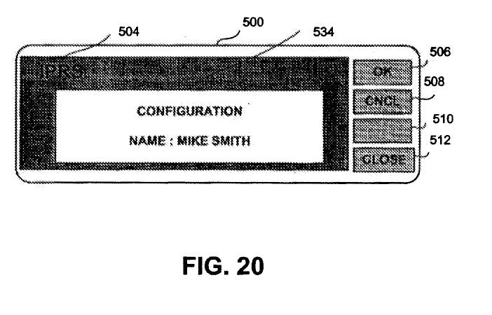

FIG. 20 shows the configuration window. The configuration window 534 enables the user to insert, update, and modify self-related personal information. The configuration window 534 is displayed automatically at the first system start up, as it is obligatory for a first-time user to configure the system with self-related personal data. The user modifies the information via the utilization of the standard available keyboard installed on the client device. The “OK” control button 506 effects the updating of the information stored within the system. The “Cancel” control button 508 is operative in deleting the text typed. After the activation of the “OK” control button 506 the program examines the text introduced by the user, rejects invalid text, and suitably notifies the user. Subsequently the user could repeat the process of introducing configuration text until the text is validated, approved, and accepted by the program.

It would be easily understood by a person with ordinary skill in the art that the user interface and the underlying program logic associated with a preferred embodiment of the present invention was set forth hereinabove with the intention of enabling a ready understanding of the concepts of the proposed system and method. The interface described is exemplary only and many other different display methods involving diverse graphical elements such as pull-down menus, list boxes, radio buttons, and the like could be used in other preferred embodiments of the present invention. In addition the program flow could substantially differ in other preferred embodiments to support additional advanced functions, which could be contemplated, and implemented during the realization of the proposed method and system. Some useful features could be added to the method and system, such as providing a busy message for a calling user while the user called retrieving the online users list, providing a busy message to a calling user while the user called is placing a call, the addition of a “Do not answer” warning button to effect the termination of an unwanted call while the user called is talking, an improved online users list having additional data and a scroll position indicator, and the like.

It will be appreciated by persons skilled in the art that the present invention is not limited to what has been particularly shown and described hereinabove. Rather the scope of the present invention is defined only by the claims, which follow.

1-58. (canceled)

59. A method of implementing a two way like radio communication network between two or more users over an existing communication network comprising:
establishing a sub group of users from said existing communication network to participate in said two way radio like communication network;
designating a server to control communications of the sub group so that a single user will transmit over the communication network at a time;
receiving at said server a request to transmit by a user of said sub group;
said designated server authorizing said user to transmit if the communication network is available for transmitting;
accepting transmissions from the user from said sub group;
delivering said transmissions to the other users of said sub group;
wherein said transmissions are transmitted as data packets using the Internet Protocol.

60. A method according to claim 59, wherein said establishing comprises creating a list of the users belonging to said sub group and an address for routing data packets to said users.

61. A method according to claim 60, wherein said list further comprises a status value for each user; wherein said status value indicates if the user is available to receive transmissions from the other users of said sub group.

62. A method according to claim 60, wherein said list is provided to each user of said sub group.

63. A method according to claim 60, wherein said list is provided to said designated server.

64. A method according to claim 59, wherein said existing communication network is a mobile telephone network.

65. A method according to claim 59, wherein said existing communication network is a land based telephone network.

66. A method according to claim 59, wherein said existing communication network is a mixture of interconnected mobile and land based telephone networks.

67. A method according to claim 59, wherein said transmissions are transmitted using the communication devices of said existing communication network.

68. A method according to claim 59, wherein said transmissions are transmitted using communication devices, which are adapted to support implementing two way radio communication over the existing communication network.

69. A method according to claim 68, wherein said adaptation comprises programming the existing communication devices.

70. A method according to claim 59, wherein a user from said sub group obtains an address for communicating with another user of said sub group by communicating the other user using said existing communication network.

71. A method according to claim 63, wherein a user from said sub group obtains an address for communicating with another user of said sub group by querying said server.

72. A method according to claim 59, wherein communication transmissions between two members of said sub group are routed differently than communication transmissions between two members of said existing communication network.

73. A method according to claim 67, wherein said transmissions are performed by pressing a predefined key on the communication devices.

74. A system implementing two way like radio communication comprising:
a communication network;
a sub group of communication devices for communicating over said communication network;
a designated server to control communications of the sub group so that a single user will transmit over the communication network at a time;
wherein said server is adapted to:
1) receive a request to transmit from a user of said sub group;
2) to authorize said user to transmit if the communication network is available;
3) to accept a transmission from said user;
4) to deliver said transmission to the other users of said sub group; and
wherein said transmissions are transmitted as data packets using the Internet protocol.

75. A computer readable storage medium containing a set of instructions for a general purpose computer, the set of instructions comprising:
commands for defining a sub group of users from the users of an existing communication network;
commands for enabling said sub group of users to transmit simultaneously to the other members of said sub group of users.

76. A method according to claim 59, wherein said designated server is connected to said existing communication network and accessible by the users of said sub-group but is not the communication device of a user of said sub group.

77. A method according to claim 59, wherein said designated server is the communication device of a user of said sub-group.

78. A method according to claim 59, wherein said transmissions are limited to conform to a specific time limit.
